(19) United States
(12) Patent Application Publication
(10) Pub. No.: US 2023/0184175 A1
(43) Pub. Date: Jun. 15, 2023

(54) SYSTEMS AND METHODS FOR ALIGNING A GEARBOX OF A GAS TURBINE ENGINE

(71) Applicant: General Electric Company, Schenectady, NY (US)

(72) Inventors: Nagashiresha Gontla, Bangalore (IN); Ravindra Shankar Ganiger, Bangalore (IN)

(21) Appl. No.: 17/587,466

(22) Filed: Jan. 28, 2022

(30) Foreign Application Priority Data
Dec. 9, 2021 (IN) 202111057289

(51) Int. Cl. F02C 9/00

(52) U.S. Cl. CPC F02C 9/00; F05D 2260/4031; F05D 2220/32; F05D 2270/00

(57) ABSTRACT

A gas turbine engine includes a turbomachine having a compressor, a combustor, and a turbine in serial flow order. The turbomachine includes a low pressure shaft, a gearbox, a motor, a fan shaft, and a compressor forward frame. The low pressure shaft is configured to be driven by the turbine and is configured to drive the gearbox. The motor is also configured to drive the gearbox. The gearbox is configured to drive the fan shaft. A connection is provided between the compressor forward frame and at least one of the motor and the gearbox.

### PRIORITY INFORMATION

The present application claims priority to Indian Patent Application Serial Number 202111057289 filed on Dec. 9, 2021.

### FIELD

The present disclosure relates to a gas turbine engine with a gearbox.

### BACKGROUND

A gas turbine engine generally includes a turbomachine and a rotor assembly. The turbomachine may include a low pressure shaft that is connected to a gearbox. The gearbox drives a fan shaft of the rotor assembly and determines a speed of the fan shaft relative to a speed of the low pressure shaft.

At high speeds, the low pressure shaft may be bowed relative to other structures due to back bone bending (e.g., transverse deflection of lightweight cases due to aero and maneuver loads) or thermal gradients. For example, the gearbox may be deflected relative to the low pressure shaft by the bowing and the gear system may lose parallelism with a central axis. There may be misalignment between a gear driven by the low pressure shaft and a gear driving the fan shaft.

This misalignment may lead to efficiency losses and potential reduced life of the gear system due to increased concentrated stresses. Accordingly, improvements to the alignment of the gearbox of a turbofan engine would be welcomed in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a schematic illustration of a compressor forward frame of the gas turbine engine, in accordance with an exemplary aspect of the present disclosure.

FIG. 3 is an illustration of a method, in accordance with an exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiment as it is oriented in the drawing figures. However, it is to be understood that the disclosure may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The term “turbomachine” or “turbomachinery” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” at the engine.

The present disclosure is generally related to systems and methods configured to reduce or remove misalignment between a low pressure shaft and a gearbox of an engine. The gearbox may be connected to a compressor forward frame or a fan hub frame to support the gearbox. For example, the gearbox may be flexibly connected to the compressor forward frame to allow the gearbox some deflection to maintain alignment with an input shaft to the gearbox. For example, the flexible connections may include a spring and damper system. Alternatively, the gearbox may be rigidly connected to the compressor forward frame to reduce the deflection of the gearbox and maintain alignment.

Additionally, support structures on one or both sides of the gearbox may be connected to the compressor forward frame to remove or reduce misalignment between the low pressure shaft and the gearbox. For example, at least one of a motor and a generator may be on a low pressure shaft side of the gearbox and a fan shaft support for a fan shaft may be on a fan shaft side of the gearbox. The motor, generator, and fan shaft support may be flexibly or rigidly connected to the compressor forward frame to provide support to the input shaft to the gearbox and the output shaft from the gearbox, thereby providing support to the gearbox to maintain alignment with the input shaft to the gearbox and the output shaft from the gearbox.

A clutch may connect or disconnect the low pressure shaft from an intermediate shaft where the intermediate shaft is the input shaft to the gearbox. When connected, the low pressure shaft drives the intermediate shaft. When disconnected, the intermediate shaft may rotate independently of the low pressure shaft. The motor is selectively coupled to the intermediate shaft and may additionally or independently drive the intermediate shaft. The generator is selectively coupled to the intermediate shaft and may draw power from the intermediate shaft.

A controller is configured to control the clutch and the motor. When a speed of the low pressure shaft is determined to be a speed at which bowing or bending may occur (e.g., a threshold speed), the controller may disconnect the low pressure shaft from the intermediate shaft and drive the intermediate shaft with the motor. Here, the low pressure shaft is disconnected to reduce or remove misalignment between the low pressure shaft and the gearbox.

The engine may include a low pressure booster aft of a fan and driven by the fan shaft to provide additional power to the core and regulate the speed of the fan.

Benefits of the systems and methods described herein include alignment of the gearbox with the input shaft and the output shaft to increase the efficiency and life of the gear system.

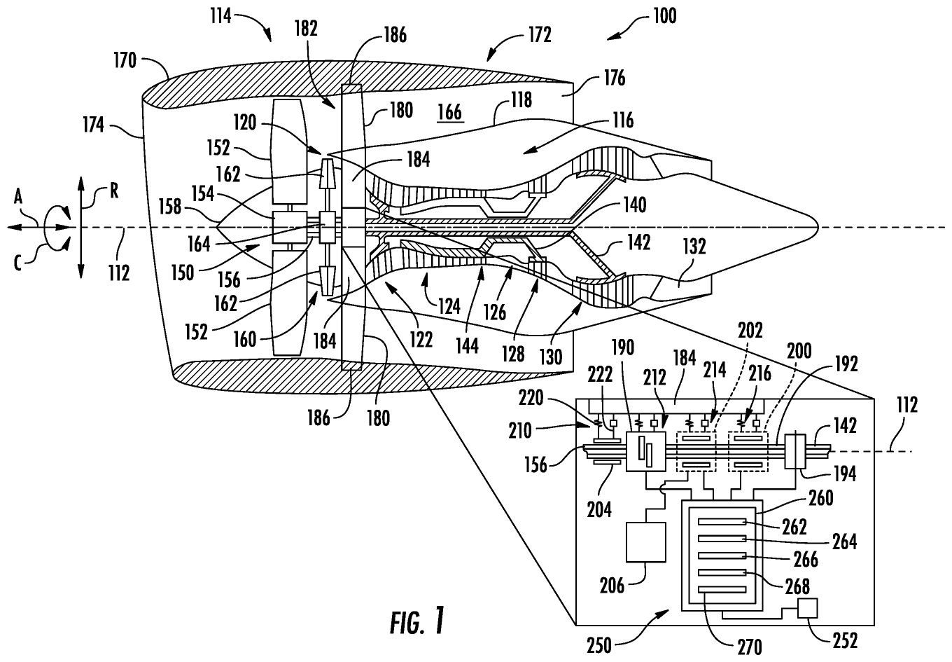

Referring now to the drawings, wherein identical numerals indicate the same elements throughout the figures, FIG. 1 is a schematic cross-sectional view of a gas turbine engine in accordance with an exemplary embodiment of the present disclosure. More particularly, for the embodiment of FIG. 1, the gas turbine jet engine is an aeronautical, turbofan engine 100, configured to be mounted to an aircraft, such as in an under-wing configuration or tail-mounted configuration.

As shown in FIG. 1, the turbofan engine 100 defines an axial direction A (extending parallel to a centerline axis 112 provided for reference), a radial direction R, and a circumferential direction C (i.e., a direction extending about the axial direction A).

In general, the turbofan engine 100 includes a fan section 114 and a turbomachine 116 disposed downstream from the fan section 114. The turbomachine 116 is sometimes also, or alternatively, referred to as a “core turbine engine”.

The turbomachine 116 includes an outer casing 118 that is substantially tubular and defines an inlet 120. The outer casing 118 encases, in serial flow relationship: a compressor section including a first, booster, or low pressure (LP) compressor 122 and a second, high pressure (HP) compressor 124; a combustion section including a combustor 126; a turbine section including a first, high pressure (HP) turbine 128 and a second, low pressure (LP) turbine 130; and a jet exhaust nozzle section 132.

A high pressure (HP) shaft 140 or spool drivingly connects the HP turbine 128 to the HP compressor 124. A low pressure (LP) shaft 142 or spool drivingly connects the LP turbine 130 to the LP compressor 122. The compressor section, combustion section, turbine section, and jet exhaust nozzle section 132 are arranged in serial flow order and together define a core air flowpath 144 through the turbomachine 116.

The fan section 114 includes a variable pitch fan 150. The fan 150 includes a plurality of fan blades 152 coupled to a disk 154 in a spaced apart manner. As depicted, the fan blades 152 extend outwardly from disk 154 generally along the radial direction R.

The fan blades 152 may be operatively coupled to one or more suitable actuation members. For example, the actuation members may be configured to vary the pitch of the fan blades 152 with respect to a pitch axis.

A fan shaft 156 is operatively connected to and drives the fan 150. The fan blades 152 and disk 154 are together rotatable about the centerline axis 112 by the fan shaft 156. The disk 154 is covered by a rotatable front nacelle 158 aerodynamically contoured to promote an airflow through the plurality of fan blades 152.

The fan section 114 further includes a low pressure booster 160 at the inlet 120 of the turbomachine 116. The low pressure booster 160 includes a plurality of rotatable blades 162 coupled to a disk 164 in a spaced apart manner. As depicted, the rotatable blades 162 extend outwardly from disk 164 generally along the radial direction R. The fan shaft 156 is operatively connected to and drives the low pressure booster 160. The rotatable blades 162 and disk 164 are together rotatable about the centerline axis 112 by the fan shaft 156.

The fan section 114 includes an annular fan casing or outer nacelle 170 that at least partially, and for the embodiment depicted, circumferentially, surrounds the fan 150 and at least a portion of the turbomachine 116. A downstream section 172 of the nacelle 170 extends over an outer portion of the turbomachine 116 so as to define a bypass airflow passage 166.

During operation of the turbofan engine 100, a volume of air enters the turbofan engine 100 through an associated inlet 174 of the nacelle 170 and/or fan section 114. As the volume of air passes across fan blades 152, a first portion of the air is directed or routed into the bypass airflow passage 166 and a second portion of the air is directed or routed into the core air flowpath 144.

The pressure of the second portion of air is increased as it is routed through the LP compressor 122 and the HP compressor 124 and into the combustor 126. More specifically, the compressor section, including the LP compressor 122 and HP compressor 124, defines an overall pressure ratio during operation of the turbofan engine 100 at a rated speed. The overall pressure ratio refers to a ratio of an exit pressure of the compressor section (i.e., a pressure of the second portion of air at an aft end of the compressor section) to an inlet pressure of the compressor section (i.e., a pressure of the second portion of air at the inlet 120 to the compressor section).

The compressed second portion of air from the compressor section mixes with fuel and is burned within the combustion section to provide combustion gases. The combustion gases are routed from the combustor 126, through the HP turbine 128 where a portion of thermal and/or kinetic energy from the combustion gases is extracted via sequential stages of HP turbine stator vanes that are coupled to the outer casing 118 and HP turbine rotor blades that are coupled to the HP shaft 140 or spool, thus causing the HP shaft 140 or spool to rotate, thereby supporting operation of the HP compressor 124.

The combustion gases are then routed through the LP turbine 130 where a second portion of thermal and kinetic energy is extracted from the combustion gases via sequential stages of LP turbine stator vanes that are coupled to the outer casing 118 and LP turbine rotor blades that are coupled to the LP shaft 142 or spool, thus causing the LP shaft 142 or spool to rotate, thereby supporting operation of the LP compressor 122 and/or rotation of the fan 150 and low pressure booster 160.

The combustion gases are subsequently routed through the jet exhaust nozzle section 132 of the turbomachine 116 to provide propulsive thrust. Simultaneously, the pressure of the first portion of air is substantially increased as the first portion of air is routed through the bypass airflow passage 166 before it is exhausted from a fan nozzle exhaust section 176 of the turbofan engine 100, also providing propulsive thrust. The HP turbine 128, the LP turbine 130, and the jet exhaust nozzle section 132 at least partially define a hot gas path for routing the combustion gases through the turbomachine 116.

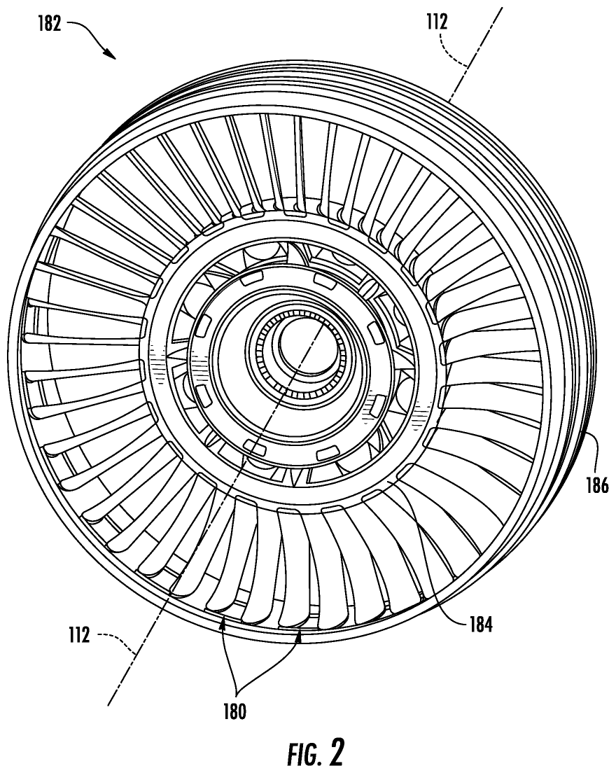

Referring to FIGS. 1 and 2, with FIG. 2 showing an exemplary fan frame assembly in greater detail, for the embodiment depicted, the nacelle 170 is supported relative to the turbomachine 116 by a plurality of outlet guide vanes 180 (e.g., circumferentially-spaced). A fan frame assembly 182 may include a compressor forward frame 184 (e.g., an inner, circular frame member) and a fan case 186 (e.g., an outer, circular framer member). The outlet guide vanes 180 are supported between the compressor forward frame 184 and the fan case 186. The outlet guide vanes 180 extend in a radial direction from the compressor forward frame 184 to the fan case 186.

The fan case 186 may be connected to the nacelle 170 such that the fan frame assembly 182 supports the nacelle 170 and positions the nacelle 170 around the turbomachine 116. The compressor forward frame 184 may be integral to or attach to the turbomachine 116 (e.g., to the outer casing 118).

Referring to a detailed view of a portion of the engine 100 in FIG. 1, showing elements connecting the LP shaft 142 and the fan shaft 156 at the compressor forward frame 184, the fan shaft 156 is connected to an output of and is driven by a gearbox 190. The LP shaft 142 is selectively connected to an intermediate shaft 192 by a clutch 194. The intermediate shaft 192 is connected to an input of and drives the gearbox 190 to drive the fan shaft 156. A fan shaft support 204 or other shaft support structure may be provided to support the fan shaft 156.

The gearbox 190, a motor 200, a generator 202, and the fan shaft support 204 are connected to the compressor forward frame 184 as described in further detail below.

The motor 200 and the generator 202 are selectively coupled to the intermediate shaft 192. For example, the motor 200 and the generator 202 may each have a geared connection to the intermediate shaft 192. A controller (e.g., controller 250) is configured to engage a gear of the motor/generator 200/202 with a gear of the intermediate shaft 192.

In some embodiments, an electric machine (e.g., motor 200 and generator 202) can operate as a motor or a generator.

The motor 200 is configured to selectively drive the intermediate shaft 192 and the generator 202 is configured to selectively draw power from the intermediate shaft 192. For example, the motor 200 is configured to convert electric energy into rotation of the intermediate shaft 192 (e.g., apply a torque to the intermediate shaft 192). The generator 202 is configured to convert rotation of the intermediate shaft 192 to electric energy.

The motor 200 may generally include a stator and a rotor, the rotor rotatable relative to the stator. Additionally, the motor 200 may be configured in any suitable manner for converting electrical power to mechanical power. For example, the motor 200 may be configured as an asynchronous or induction electric machine operable to utilize alternating current (AC) electric power. Alternatively, the motor 200 may be configured as a synchronous electric machine operable to utilize alternating current (AC) electric power or direct current (DC) electric power. In such a manner it will be appreciated that the stator, the rotor, or both may generally include one or more of a plurality of coils or winding arranged in any suitable number of phases, one or more permanent magnets, one or more electromagnets, etc. Other exemplary motors or electric machines may be used as well.

The generator 202 may generally include a stator and a rotor, the rotor rotatable relative to the stator. The generator 202 may be configured in any suitable manner for converting mechanical power to electrical power. For example, the generator 202 may be configured as an asynchronous or induction electric machine operable to generate alternating current (AC) electric power. Alternatively, the generator 202 may be configured as a synchronous electric machine operable to generate alternating current (AC) electric power or direct current (DC) electric power. In such a manner it will be appreciated that the stator, the rotor, or both may generally include one or more of a plurality of coils or winding arranged in any suitable number of phases, one or more permanent magnets, one or more electromagnets, etc. Other exemplary generators or electric machines may be used as well.

For the exemplary embodiment depicted, the motor 200 and the generator 202 are generally configured coaxially with the centerline axis 112 of the turbofan engine 100, which for the embodiment depicted means the motor 200 and generator 202 are also configured coaxially with the fan shaft 156, intermediate shaft 192, and the LP shaft 142. With such a configuration, the motor 200 and generator 202 may be referred to as being “embedded.” In other embodiments, however, one or both of the motor 200 and the generator 202 may not be coaxial with the centerline axis 112 of the turbofan engine 100, and instead may be offset and connected through, e.g., a suitable geartrain.

An energy storage device 206 is configured to store electric energy generated by the generator 202. The energy storage device 206 may provide stored electric energy to the motor 200. A power conditioning and distribution device may connect the generator 202 to the energy storage device 206. The power conditioning and distribution device may include power electronics or similar structure for, e.g., converting electric power between AC and DC electric power.

It will be appreciated that, in other exemplary embodiments, the motor 200 may additionally or alternatively be in electrical communication with any other suitable power source and/or power storage assembly.

The gearbox 190 (e.g., a power gear box or other speed control device) includes a plurality of gears for changing (e.g., stepping down) the rotational speed of the LP shaft 142 and/or the intermediate shaft 192 to a more efficient rotational speed for the fan 150. For the embodiments depicted, the turbomachine 116 and the motor 200 are operably coupled to the fan 150 through the gearbox 190.

As the gearbox 190 connects the LP shaft 142 and the intermediate shaft 192 to the fan shaft 156, the gearbox 190 may disassociate the speed of the fan 150 from the speed of the LP turbine 130 (or turbomachine 116) and/or from the speed of the motor 200.

The clutch 194 is configured to selectively connect the LP shaft 142 (e.g., the turbomachine 116) to the intermediate shaft 192. As will be appreciated, when the clutch 194 disconnects the intermediate shaft 192 from the LP shaft 142, the intermediate shaft 192 may rotate independently of the LP shaft 142. By contrast, when the clutch 194 connects the intermediate shaft 192 with the LP shaft 142, the intermediate shaft 192 and LP shaft 142 are rotatably fixed to one another such that the intermediate shaft 192 and LP shaft 142 rotate at the same speed.

The motor 200 and the LP shaft 142 are on opposite sides of the clutch 194. As such, the clutch 194 is configured to disconnect the intermediate shaft 192 from the LP shaft 142 while the intermediate shaft 192 remains connected to the gearbox 190 and fan shaft 156. Here, the intermediate shaft 192 is configured to be driven by the motor 200.

When the clutch 194 connects the LP shaft 142 to the intermediate shaft 192, both the LP shaft 142 and the motor 200 are able to drive the gearbox 190 and the fan shaft 156. This configuration enables multiple modes of operation as described in further detail below.

Referring to FIGS. 1-3, the gearbox 190, the motor 200, the generator 202, and the fan shaft 156 (e.g., via a fan shaft support 204) are connected to the compressor forward frame 184. The fan shaft support 204 may include a damper bearing, a rotor bearing (e.g., a roller bear, a ball bearing, a tapered roller bearing, etc.), or another rotational support for the fan shaft 156 to support the fan shaft 156 relative to the compressor forward frame 184.

Referring to FIG. 1, for example, the fan shaft support 204 is connected to the compressor forward frame 184 by a first connection 210, the gearbox 190 is connected to the compressor forward frame 184 by a second connection 212, the generator 202 is connected to the compressor forward frame 184 by a third connection 214, and the motor 200 is connected to the compressor forward frame 184 by a fourth connection 216. The connections 210, 212, 214, 216 to the compressor forward frame 184 support the fan shaft support 204 (e.g., the fan shaft 156), the gearbox 190, the generator 202, and the motor 200, for example, when the engine 100 experiences bowing to maintain alignment between the LP shaft 142 and the gearbox 190.

In certain embodiments, two or more of the fan shaft support 204, the gearbox 190, the generator 202, and the motor 200 are additionally or alternatively connected to one another. For example, the motor 200 may be connected to the generator 202, which is connected to the compressor forward frame 184 by the third connection 214, such that the motor 200 is supported by the compressor forward frame 184 through connection to the generator 202.

In certain embodiments, one or more of the connections 210, 212, 214, 216 may be flexible connections. For example, the connections 210, 212, 214, 216 may include a spring 220 and a damper 222. Here, the connections 210, 212, 214, 216 to the compressor forward frame allow some deflection and provide support to the fan shaft support 204 (e.g., the fan shaft 156), the gearbox 190, the generator 202, and the motor 200 to maintain alignment between the LP shaft 142 and the gearbox 190.

In certain alternative embodiments, however, one or more of the connections 210, 212, 214, 216 may be rigid connections. Here, the connections 210, 212, 214, 216 to the compressor forward frame 184 provide support to the fan shaft support 204 (e.g., the fan shaft 156), the gearbox 190, the generator 202, and the motor 200 to maintain alignment between the LP shaft 142 and the gearbox 190.

A controller 250 is configured to control the clutch 194, the motor 200, the generator 202, and the gearbox 190. In particular, the controller 250 controls the clutch 194 to connect or disconnect the LP shaft 142 and the intermediate shaft 192, controls the motor 200 to selectively drive (e.g., apply a torque to) the intermediate shaft 192, controls the generator 202 to selectively draw power from (e.g., apply torque to) the intermediate shaft 192, and controls the gearbox 190 to determine the relative speeds between the intermediate shaft 192 and the fan shaft 156.

In general, the controller 250 is configured to receive data sensed from the one or more sensors 252 (e.g., speed, torque) or commands (e.g., a desired torque) received from one or more systems and, e.g., make control decisions based on the received data.

In one or more exemplary embodiments, the controller 250 may be a stand-alone controller, or alternatively, may be integrated into one or more of a controller for the turbofan engine 100, a controller for an aircraft including the turbofan engine 100, a full authority digital engine control (FADEC), an engine control unit (ECU), and the like.

Referring particularly to the operation of the controller 250, in at least certain embodiments, the controller 250 can include one or more computing device(s) 260. The computing device(s) 260 can include one or more processor(s) 262 and one or more memory device(s) 264. The one or more processor(s) 262 can include any suitable processing device, such as a microprocessor, microcontroller, integrated circuit, logic device, and/or other suitable processing device. The one or more memory device(s) 264 can include one or more computer-readable media, including, but not limited to, non-transitory computer-readable media, RAM, ROM, hard drives, flash drives, and/or other memory devices.

The one or more memory device(s) 264 can store information accessible by the one or more processor(s) 262, including computer-readable instructions 266 that can be executed by the one or more processor(s) 262. The instructions 266 can be any set of instructions that, when executed by the one or more processor(s) 262, cause the one or more processor(s) 262 to perform operations. In some embodiments, the instructions 266 can be executed by the one or more processor(s) 262 to cause the one or more processor(s) 262 to perform operations, such as any of the operations and functions for which the controller 250 and/or the computing device(s) 260 are configured, the operations for operating the turbofan engine 100 (e.g., methods described below), as described herein, and/or any other operations or functions of the one or more computing device(s) 260.

The instructions 266 can be software written in any suitable programming language or can be implemented in hardware. Additionally, and/or alternatively, the instructions 266 can be executed in logically and/or virtually separate threads on processor(s) 262.

The memory device(s) 264 can further store data 268 that can be accessed by the processor(s) 262. For example, the data 268 can include data indicative of speeds, torques, engine/aircraft operating parameter or conditions, and/or any other data and/or information described herein.

The computing device(s) 260 can also include a network interface 270 used to communicate, for example, with the other components of the turbofan engine 100, the aircraft incorporating the gas turbine engine, etc. For example, in the embodiment depicted, the turbofan engine 100 may operate to limit a speed of the LP shaft 142, to reach a desired torque, etc. The controller 250 is operably coupled to the one or more aircraft systems (e.g., a flight management system or other aircraft control system) through, e.g., the network interface 270, such that the controller 250 may receive data or commands indicative of speeds and torques.

The network interface 270 can include any suitable components for interfacing with one or more network(s), including for example, transmitters, receivers, ports, controllers, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

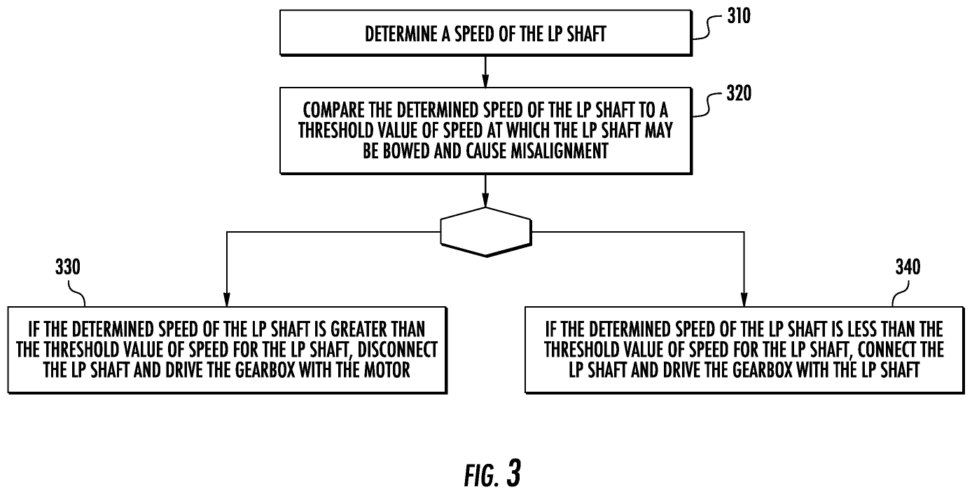

Referring to FIG. 3, the controller 250 may control the motor 200 and the clutch 194 according to a method 300 to disconnect the LP shaft 142 to prevent the LP shaft 142 from operating at a speed where bowing may occur, or at least to prevent the LP shaft 142 from being misaligned with the gearbox 190 when the engine 100 is susceptible to bending or bowing.

According to a first step 310, the controller 250 may determine a speed of the LP shaft 142. For example, the controller 250 may receive data indicative of a desired torque or speed to the fan shaft 156 (e.g., from an aircraft controller). The controller 250 may determine a speed of the LP shaft 142 to achieve the desired torque or speed of the fan shaft 156, or alternatively may determine other engine parameter(s) that correlate to the speed of the LP shaft 142 to achieve the desired torque or speed of the fan shaft 156 (e.g., an LP turbine speed, an LP compressor speed, a temperature and/or pressure associated with the LP turbine or LP compressor, etc.). For example, the speed of the LP shaft 142 can be determined directly, based on a speed of the HP shaft 140, based on a desired torque of the fan shaft 156, etc.

According to a second step 320, the controller 250 may compare the determined speed of the LP shaft 142 to a threshold value. The threshold value may be a speed at which the LP shaft 142 may be bowed and cause misalignment, or at which the engine 100 is susceptible to bending or bowing, potentially creating a misalignment of the LP shaft 142 with the gearbox 190.

In other exemplary aspects, as noted above, the data determined at step 310 may be data indicative of the speed of the LP shaft 142, and the threshold value used at step 320 may similarly be a threshold value of similar data indicative of the speed of the LP shaft 142.

According to a third step 330, if the determined speed of the LP shaft 142 is greater than the threshold value of speed for the LP shaft 142, the controller 250 controls the clutch 194 to disconnect the LP shaft 142 from the intermediate shaft 192. More specifically, in certain exemplary aspects, in response to determining the speed of the LP shaft 142 is greater than the threshold value of speed for the LP shaft 142, the controller 250 may control the clutch 194 to disconnect the LP shaft 142 from the intermediate shaft 192. In such a case, the controller 250 controls the motor 200 to drive the intermediate shaft 192 with the motor 200 to achieve the determined speed. For example, the controller 250 controls the motor 200 to apply a torque to the intermediate shaft 192 to achieve the desired torque or speed for the fan shaft 156 (e.g., according to a gear ratio of the gearbox 190).

Once the LP shaft 142 is disconnected, the turbomachine 116 may operate such that the speed of the LP shaft 142 is reduced.

Additionally, or alternatively, for example when another electric machine is provided in the turbomachine 116, such as an embedded electric machine (e.g., generator) in the turbine section of the turbomachine 116, the turbomachine 116 may be operated to drive the embedded electric machine to produce electric power.

According to a fourth step 340, if the determined speed of the LP shaft 142 is less than the threshold value of speed for the LP shaft 142, the controller 250 controls the clutch 194 to connect (or to remain connected if already connected) the LP shaft 142 to the intermediate shaft 192. More specifically, in certain exemplary aspects, in response to determining the speed of the LP shaft 142 is less than the threshold value of speed for the LP shaft 142, the controller 250 may control the clutch 194 to connect (or to remain connected if already connected) the LP shaft 142 to the intermediate shaft 192. The controller 250 may control the motor 200 to cease driving the intermediate shaft 192 with the motor 200.

It should be appreciated that the exemplary turbofan engine 100 depicted in FIG. 1 is by way of example only, and that in other exemplary embodiments, the turbofan engine 100 may have any other suitable configuration. For example, aspects of the present disclosure may be utilized with any other suitable aeronautical gas turbine engine, such as a turboshaft engine, turboprop engine, turbojet engine, etc. Further, aspects of the present disclosure may further be utilized with any aeroderivative gas turbine engine, such as a nautical gas turbine engine.

Other gas turbine engines to which the present disclosure may be applied may have alternative configurations. By way of example such engines may have an alternative number of interconnecting shafts (e.g., two) and/or an alternative number of compressors and/or turbines. Further the engine may be configured as an unducted gas turbine engine (e.g., excluding the outer nacelle 170), etc.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A gas turbine engine, comprising a turbomachine having a compressor, a combustor, and a turbine in serial flow order, the turbomachine further comprising a low pressure shaft is configured to be driven by the turbine; a gearbox, wherein the low pressure shaft and is configured to drive the gearbox; a motor configured to drive the gearbox; a fan shaft, wherein the gearbox is configured to drive the fan shaft; a compressor forward frame; and a connection between: the compressor forward frame; and at least one of the motor and the gearbox.

The gas turbine engine of one or more of these clauses, wherein the connection is rigid.

The gas turbine engine of one or more of these clauses, wherein the connection is flexible.

The gas turbine engine of one or more of these clauses, wherein the connection includes at least one of a spring and a damper.

The gas turbine engine of one or more of these clauses, wherein the motor and the gearbox are connected to the compressor forward frame.

The gas turbine engine of one or more of these clauses, further comprising a fan shaft support configured to support the fan shaft, wherein the fan shaft support is connected to the compressor forward frame.

The gas turbine engine of one or more of these clauses, wherein at least one of the motor, the gearbox, and the fan shaft support is connected to one other of the motor, the gearbox, and the fan shaft support.

The gas turbine engine of one or more of these clauses, further comprising: a clutch; and an intermediate shaft, wherein the intermediate shaft is configured to connect the low pressure shaft to the gearbox, wherein the low pressure shaft is connected to the intermediate shaft by the clutch.

The gas turbine engine of one or more of these clauses, further comprising a generator selectively coupled to the intermediate shaft, wherein the generator is connected to the compressor forward frame.

The gas turbine engine of one or more of these clauses, wherein the motor is selectively coupled to the intermediate shaft.

The gas turbine engine of one or more of these clauses, further comprising a controller configured to control the motor and the clutch.

The gas turbine engine of one or more of these clauses, wherein the controller is configured to, based on a speed of the low pressure shaft: disconnect the low pressure shaft from the intermediate shaft; and drive the intermediate shaft with the motor.

The gas turbine engine of one or more of these clauses, wherein the speed is compared to a threshold speed for the low pressure shaft.

The gas turbine engine of one or more of these clauses, wherein the speed is determined based on a desired torque for the fan shaft.

The gas turbine engine of one or more of these clauses, wherein the intermediate shaft is driven by the motor to achieve the desired torque for the fan shaft.

A method, comprising determining a speed of a low pressure shaft; comparing the speed of the low pressure shaft to a threshold value of speed for the low pressure shaft; in response to determining the speed of the low pressure shaft is greater than the threshold value of speed for the low pressure shaft: disconnecting the low pressure shaft from a gearbox; and driving the gearbox with a motor.

The method of one or more of these clauses, wherein determining the speed of the low pressure shaft comprises: receiving data indicative of a desired torque or speed to a fan shaft; and determining the speed of the low pressure shaft based on the received data indicative of the desired torque or speed to the fan shaft and a ratio of a first speed of the low pressure shaft to a second speed of the fan shaft, wherein the ratio is based on a ratio of gears in a gearbox.

The method of one or more of these clauses, wherein driving the gearbox with the motor comprises driving the gearbox with the motor to achieve the desired torque or speed to the fan shaft.

The method of one or more of these clauses, further comprising: in response to determining the speed of the low pressure shaft is less than the threshold value of speed for the low pressure shaft, driving the gearbox with the low pressure shaft.

The method of one or more of these clauses, further comprising: in response to determining the speed of the low pressure shaft is less than the threshold value of speed for the low pressure shaft, connecting the low pressure shaft to the gearbox.

1. A gas turbine engine, comprising:
a turbomachine having a compressor, a combustor, and a turbine in serial flow order, the turbomachine further comprising a low pressure shaft configured to be driven by the turbine;
a gearbox, wherein the low pressure shaft is configured to drive the gearbox;
a motor configured to drive the gearbox;
a fan shaft, wherein the gearbox is configured to drive the fan shaft;
a compressor forward frame; and
a connection between:
the compressor forward frame; and
at least one of the motor and the gearbox.

2. The gas turbine engine of claim 1, wherein the connection is rigid.

3. The gas turbine engine of claim 1, wherein the connection is flexible.

4. The gas turbine engine of claim 3, wherein the connection includes at least one of a spring and a damper.

5. The gas turbine engine of claim 1, wherein the motor and the gearbox are connected to the compressor forward frame.

6. The gas turbine engine of claim 5, further comprising a fan shaft support configured to support the fan shaft, wherein the fan shaft support is connected to the compressor forward frame.

7. The gas turbine engine of claim 6, wherein at least one of the motor, the gearbox, and the fan shaft support is connected to one other of the motor, the gearbox, and the fan shaft support.

8. The gas turbine engine of claim 1, further comprising:
a clutch; and
an intermediate shaft, wherein the intermediate shaft is configured to connect the low pressure shaft to the gearbox, wherein the low pressure shaft is connected to the intermediate shaft by the clutch.

9. The gas turbine engine of claim 8, further comprising a generator selectively coupled to the intermediate shaft, wherein the generator is connected to the compressor forward frame.

10. The gas turbine engine of claim 8, wherein the motor is selectively coupled to the intermediate shaft.

11. The gas turbine engine of claim 10, further comprising a controller configured to control the motor and the clutch.

12. The gas turbine engine of claim 11, wherein the controller is configured to, based on a speed of the low pressure shaft:
disconnect the low pressure shaft from the intermediate shaft; and
drive the intermediate shaft with the motor.

13. The gas turbine engine of claim 12, wherein the speed is compared to a threshold speed for the low pressure shaft.

14. The gas turbine engine of claim 12, wherein the speed is determined based on a desired torque for the fan shaft.

15. The gas turbine engine of claim 14, wherein the intermediate shaft is driven by the motor to achieve the desired torque for the fan shaft.

16. A method, comprising:
determining a speed of a low pressure shaft;
comparing the speed of the low pressure shaft to a threshold value of speed for the low pressure shaft;
in response to determining the speed of the low pressure shaft is greater than the threshold value of speed for the low pressure shaft:
disconnecting the low pressure shaft from a gearbox; and
driving the gearbox with a motor.

17. The method of claim 16, wherein determining the speed of the low pressure shaft comprises:
receiving data indicative of a desired torque or speed to a fan shaft; and
determining the speed of the low pressure shaft based on the received data indicative of the desired torque or speed to the fan shaft and a ratio of a first speed of the low pressure shaft to a second speed of the fan shaft, wherein the ratio is based on a ratio of gears in a gearbox.

18. The method of claim 17, wherein driving the gearbox with the motor comprises driving the gearbox with the motor to achieve the desired torque or speed to the fan shaft.

19. The method of claim 16, further comprising:
in response to determining the speed of the low pressure shaft is less than the threshold value of speed for the low pressure shaft, driving the gearbox with the low pressure shaft.

20. The method of claim 19, further comprising:
in response to determining the speed of the low pressure shaft is less than the threshold value of speed for the low pressure shaft, connecting the low pressure shaft to the gearbox.
